(19) United States
(12) Patent Application Publication
(10) Pub. No.: US 2024/0356104 A1
(43) Pub. Date: Oct. 24, 2024

(54) ADAPTABLE BATTERY VENTILATION ENCLOSURE WITH INTEGRATED TURBULENCE ENHANCING COVER

(71) Applicant: Spear Power Systems, Inc., Grandview, MO (US)

(72) Inventors: Wes Mossinghoff, Grandview, MO (US); Daniele Suzzi, Weiz (AT); Bas Bodenan, Antwerp (BE); Anthony Carey, Grandview, MO (US)

(21) Appl. No.: 18/579,125

(22) PCT Filed: Jul. 15, 2022
(86) PCT No.: PCT/US2022/037257

§ 371 Date: Jan. 12, 2024

Related U.S. Application Data
(60) Provisional application No. 63/222,678, filed on Jul. 16, 2021.

(51) Int. Cl. H01M 10/6563; H01M 10/613; H01M 10/658

(52) U.S. Cl. CPC H01M 10/6563; H01M 10/613; H01M 10/658

(57) ABSTRACT

Ventilation enclosures (10) for use with battery assemblies (11) and methods of cooling battery assemblies using the same are provided. The ventilation enclosures (10) comprise one or more sidewalls (14, 16) having a plurality of inwardly projecting dimples (26) formed therein. The dimples (26) physically contact a battery assembly housing (13) to provide for conductive heat transfer between the housing and the enclosure (10). The dimples (26) also improve convective heat transfer away from the battery assembly housing (13) by inducing more turbulent air flow within the space (20) located between the housing and the ventilation enclosure (10).

### CROSS-REFERENCE TO RELATED APPLICATION

This application claims the benefit of U.S. Provisional Patent Application No. 63/222,678, filed Jul. 16, 2021, which is incorporated by reference herein in its entirety.

### BACKGROUND OF THE INVENTION

### Field of the Invention

The present invention relates to ventilation enclosures for use with battery assemblies and methods of cooling battery assemblies using the same.

### Description of Related Art

In case of many industrial applications, traction batteries made of Li-ion cells, also called Energy Storage Systems (ESSs), cannot be easily cooled by means of a liquid medium e.g., water glycol mixtures). This is due to the fact that the application vehicle, hybrid, or full electric, does not include a thermo-management system which could temperate an eventual battery cooling medium. For this reason, most industrial batteries are usually either passively cooled, e.g., heat transfer to battery housing and natural convection to the outside, or actively cooled, e.g., by means of fans/blowers relying on environment air temperature. The fans are also usually positioned outside of the battery, in order to guarantee ingress protection (IP) rating to the ESS.

There are some issues with integrating fans outside of the battery, however, which include the following:
1. Complex design adaptations are needed to guarantee homogeneous flow over the battery surfaces. Without homogeneous flow, a high risk of Li-ion cells temperature spread is present, leading to unbalancing and faster aging. Air recirculation zones and unclear defined flow paths are also the consequence of a post-integration of the ventilation system.
2. Poor heat transfer coefficient over the usually flat battery surface due to predominance of laminar flow condition. To increase the thermal performance, higher volume flow rates are needed, leading to higher pressure drop and, consequently, to over-dimensioning of fans and power consumption.
3. Vibration and consequent acoustic problems due to the lack of integration between external air flow baffles/plates and battery housing.

### SUMMARY OF THE INVENTION

Embodiments of the present invention aim to resolve these problems by providing and adaptable battery ventilation enclosure with integrated airflow turbulence enhancing cover.

In one embodiment, there is provided a ventilation enclosure configured to be installed onto a battery assembly. The ventilation enclosure comprises an enclosure top comprising one or more ventilation elements installed therein and a pair of opposing sidewalls. Each of the sidewalls comprises a plurality of dimples formed therein and configured to contact an exterior housing of the battery assembly.

In another embodiment, there is provided a battery assembly comprising the ventilation enclosure according to any embodiment described herein installed thereon.

In another embodiment, there is provided a method of cooling a battery assembly. The method comprises providing a battery assembly having a ventilation enclosure installed thereon. The ventilation enclosure comprises an enclosure top comprising one or more ventilation elements installed therein and a pair of opposing sidewalls. Each of the sidewalls comprises a plurality of dimples formed therein and contacting an exterior housing of the battery assembly so as to define a space between the sidewalls and an exterior housing of the battery assembly. The method further comprises operating the one or more ventilation elements, thereby inducing airflow in the space between the sidewalls and an exterior housing of the battery assembly.

### BRIEF DESCRIPTION OF THE DRAWINGS

FIG. 1 depicts an exemplary ventilation enclosure apparatus in accordance with one embodiment of the present invention;

FIG. 2 is a cut away view of the ventilation enclosure apparatus of FIG. 1 exposing the battery module located therein; and

FIG. 3 is a cross-sectioned view of the ventilation enclosure apparatus depicting an exemplary air flow path through the apparatus.

### DETAILED DESCRIPTION

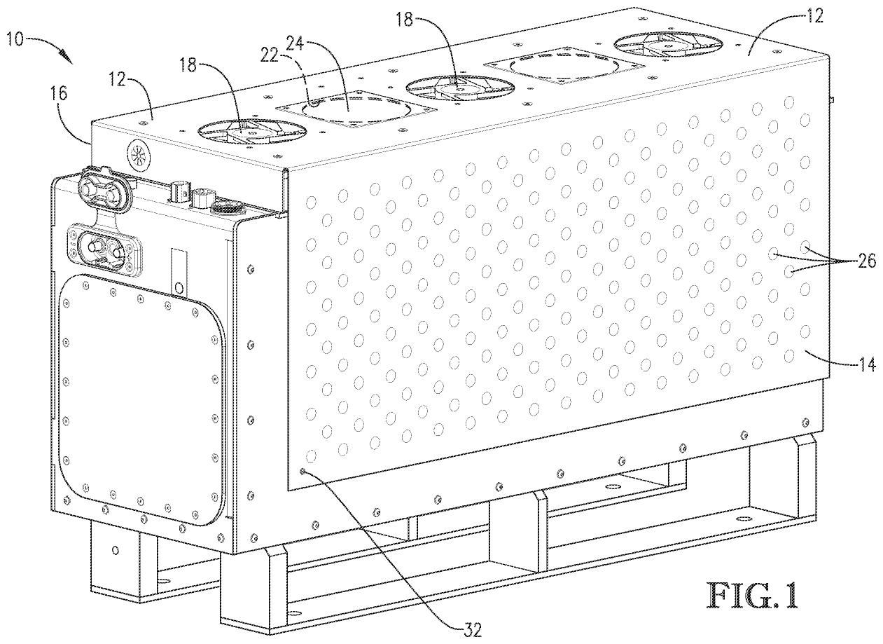

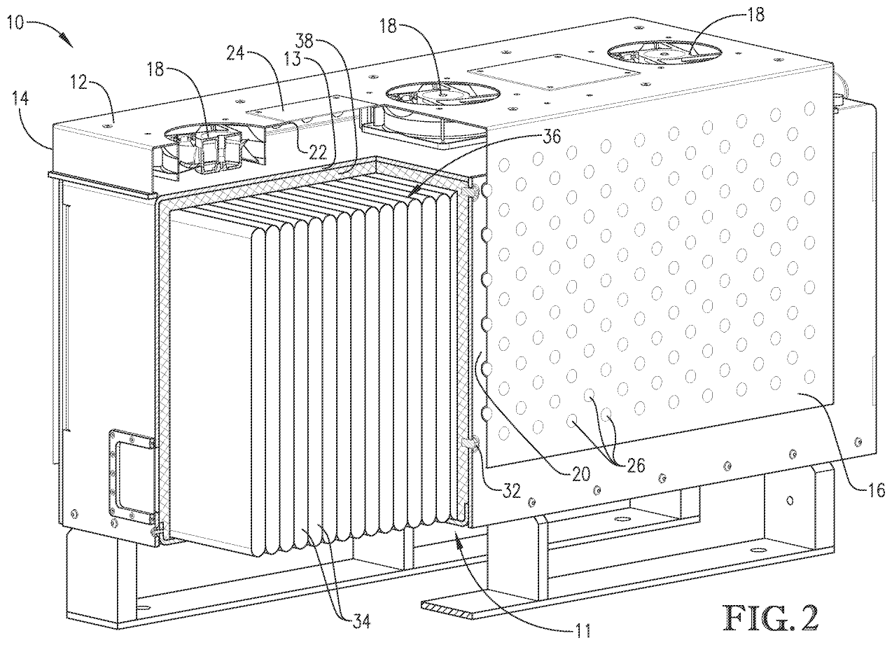

The present invention is generally concerned with a ventilation enclosure apparatus for a battery assembly and methods of cooling a battery assembly using the same. The ventilation enclosure apparatus is configured to be equipped exterior to the housing of the battery assembly. An exemplary ventilation enclosure 10 installed onto a battery assembly 11 is shown in FIGS. 1 and 2.

As shown in FIGS. 1 and 2, the ventilation enclosure 10 comprises an enclosure top 12 and a pair of opposing sidewalls 14, 16 (i.e., side covers). The enclosure top 12 comprises one or more ventilation elements 18 (e.g., fans) operable to induce airflow in the space 20 between the battery assembly housing 13 and the enclosure structure 10. In certain embodiments, the enclosure top may further comprise one or more seats 22 where ventilation elements 18 may be added or removed depending, for example, on the thermal requirement of the battery assembly 11. Although FIG. 1 shows the ventilation elements 18 as a single row along the centerline of the enclosure top 12, it should be understood that the ventilation elements 18 may be positioned in other arrangements, for example in multiple rows and/or columns, and may be offset from the centerline of the enclosure 10. Unused ventilation/fan seats 22 can be simply closed by means of a cap 24. The ventilation elements 18 can be operated in suction mode extracting air from inside of the enclosure 10 toward the top 12 or in blower mode pushing the air from through the top 12 and into the interior of the enclosure 10.

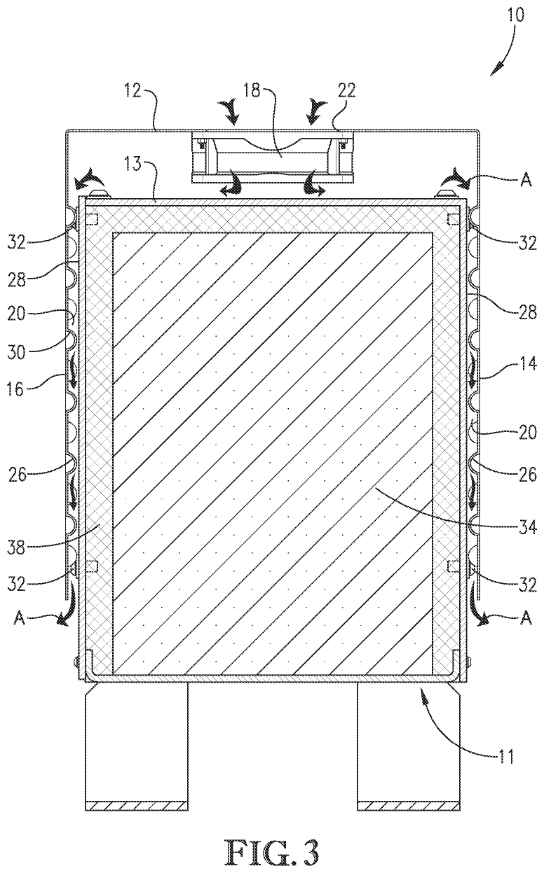

The pair of opposing sidewalls 14, 16 each comprise a plurality of dimples 26 formed therein. As best shown in FIG. 3, the plurality of dimples 26 may be in the form of hemispherical, or concavo-convex, indentions projecting from the outer surface of the sidewall 14, 16 toward the battery assembly housing 13. However, in certain embodiments, the dimples 26 may have different geometries or may have two or more different geometries to achieve the desired air flow conditions, as described in greater detail below. For example, the dimples may be square, diamond, triangular, star-shaped, or any combination thereof, when viewed in plan, but still project inwardly toward the interior of the enclosure. When installed, the dimples 26 contact the exterior surface 28 of the battery assembly housing 13. In certain embodiments, the exterior surface 30 of the dimples 26 should be open and exposed to the external environment. In addition, the dimple exterior surface 30 may have a concave configuration. As described below, the dimples 26 function as a heat sink for both conductive heat transfer via direct physical contact with the battery assembly 11, and in particular, the battery assembly housing 13, and convective heat transfer via contact with the airflow between the sidewalls 14, 16 and the battery assembly 11.

The ventilation enclosure 10 may be made from a variety of materials, although materials with high heat conductivity are preferred. In certain embodiments, the ventilation enclosure is made from metal(s) and/or heat conductive polymeric materials. The ventilation enclosure may be transparent to allow visual inspection of the battery housing, but in alternate embodiments, the ventilation enclosure could be opaque, especially when fabricated from metal(s). Additionally, although shown in FIG. 1 as having a generally rectangular geometry, the ventilation enclosure 10 (including the top wall 12 and sidewalls 14, 16, individually) may have other geometries so as to fit over and secure to different battery assembly geometries. For instance, the ventilation enclosure may comprise a single circumscribing, cylindrical (i.e., rounded) sidewall instead of sidewalls formed from planar panels.

The ventilation enclosure may be easily installed by securing the enclosure 10 to the exterior surface of the battery assembly housing 13. The side walls 14, 16 and top 12 may be installed individually or as a unitary structure. For example, when installed as a unitary structure, the open bottom of the ventilation enclosure 10 may be lowered over the top of the battery assembly housing 13 and slid into place. As shown in FIGS. 1-3, the ventilation enclosure 10 may be secured to the battery assembly 11 using simple bolt connections 32, although other fasteners and adhesives may also be used. As shown in FIG. 3, when installed, the side wall dimples 26 directly contact the battery assembly housing 13. The contact between the dimples 26 and the battery assembly housing 13 allows for easier mounting of the enclosure 10 and provides increased structural integrity of the installed system. The contact between the dimples 26 and battery assembly 11 also provides multi-directional, and preferably turbulent, airflow (represented by arrow A) in the space between the battery assembly 11 and the enclosure side walls 14, 16.

Ventilation enclosures 10 according to embodiments of the present invention can be used with, and installed onto, a variety of battery assemblies 11. As used herein, the term “battery assembly” refers to one or more battery cells 34, including battery cell stacks, and the various components associated with the battery cell(s) generally contained within an exterior battery assembly housing 13. As used herein, the term “battery cell” refers to an electrochemical cell that can generate electrical energy from a chemical reaction. The battery cell may be an electrolytic cell in which a cathode and anode are separated by an electrolyte. An exemplary battery cell for use with the present invention is a lithium-ion battery cell. There are many types of electrolytes that may be used in lithium-ion battery cells including, but not limited to mixtures of organic carbonates such as ethylene carbonate or diethyl carbonate containing complexes of lithium ions. These non-aqueous electrolytes generally use non-coordinating anion salts such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃). The battery assembly 11 may comprise one or more battery module(s) 36, including battery systems. As used herein, the term “battery module” refers to a collection of two or more battery cells. The battery cells 34 within the battery module 36 may be connected in series, in parallel, or they may be cells connected in series and cells connected in parallel within the same module. As used herein, the term “battery system” refers to a collection of two or more battery modules 36.

In certain embodiments, the battery assembly 11 may comprise a thermal barrier layer 38 (or heat spreading layer) positioned between one or more battery cells 34 and the exterior housing 13 of the battery assembly 11. The internal geometry of the battery assembly 11 can be constructed such that the thermal barrier layer 38 substantially covers one or more of the faces of each battery cell 34 (e.g., Li-ion cell). The thermal barrier layer 38 may comprise one or more sheets, which are elongated along the battery assembly housing 13 and may be folded to enhance the pressure contact with the housing. In certain embodiments, the thermal barrier layer 38 comprises a graphitic carbon sheet or sheets, which are configured to protect the battery assembly housing 13 from temperatures that could cause it to melt. The thermal barrier layer 38 advantageously transmits heat in an in-plane direction rather than in a direction normal to the plane of the layer. Thus, the thermal barrier layer 38 transmits heat that originates from a battery cell away laterally along the plane of the barrier layer 38 and the housing surface 28. This configuration allows a low thermal resistance path between the heat generating components (e.g., the Li-ion cells) and the heat sink (the forced airflow A between the housing 13 and the enclosure sidewalls 14, 16, with heat transfer improvement due to the dimples 26). This results in a smooth heat transfer between cell 34, heat spreader 38 (barrier layer), housing 13, and air A, without gap fillers, thermal pastes, pads, plastics, air gaps, etc. This configuration can be used with a variety of battery assembly geometries and designs, such as pouch, prismatic and cylindrical type cells, by simply adapting the contact surface between battery cell and the barrier layer. The inclusion of the thermal barrier layer 38 (or heat spreading layer) may advantageously lengthen the life of the battery cell(s) and protect surrounding cells in the event of thermal runaway of a cell. Exemplary thermal barrier layers 38, and battery cells 34 and assemblies 11 including thermal barrier layers, are described in International Publication Number WO 2020/204901, which is incorporated by reference herein in its entirety.

In certain embodiments, the battery assembly housing comprises a lightweight metal or metal alloy (e.g., aluminum or aluminum alloy), although other heat conducting materials may be used. As best shown in FIG. 3, the housing generally defines the exterior surface 28 of the battery assembly 11, with the battery cell(s) 34 and other battery assembly components contained therein.

In operation, embodiments of the ventilation enclosures 10 described herein provide for methods of cooling a battery assembly 11. The methods generally comprise inducing airflow A through the space 20 between the enclosure sidewalls 14, 16 and the battery assembly 11. The airflow A may be induced by the ventilation element(s) 18 in the enclosure top 12, which may have a blowing or suction operation to determine the general direction of the airflow. The sidewall dimples 26 impart a number of important effects on the airflow A. For example, the dimples 26 deflect the airflow A, thereby causing the air to wind around the dimples 26 and provide a more uniform fluid velocity (and thus more consistent and/or uniform temperature distribution) across the battery assembly housing 13. This discourages hotter/colder pockets or streaks from forming across the housing surface 28, which may occur with more linear airflow across the surface. Additionally, in certain embodiments, the dimples 26 can provide for turbulent airflow conditions, which also provide for a more consistent and/or uniform temperature distribution across the battery assembly housing 13.

During operation, heat generated by the battery assembly 11 is removed using a combination of conductive heat transfer and convective heat transfer. Heat generated by the battery cell 34 can be conducted to the optional heat spreader plate(s) 38, where the heat is dispersed over a greater area by the plate(s). Regardless of whether the heat spreader plate(s) are included, the heat is conducted to the housing 13 of the battery assembly 11. The heat is then transferred to the enclosure structure 10 by at least two mechanisms. First, the sidewall dimples 26 directly contact the battery assembly housing 13, thereby allowing for conductive heat transfer at those contact points. Second, the ventilation elements 18 cause airflow A in the space 20 between the battery assembly housing 13 and the enclosure 10, thereby allowing for convective heat transfer from the housing 13 to the airflow A and then from the airflow A to the sidewalls 14, 16. Heat transferred to the dimples 26 and sidewalls 14, 16 can then be removed from the system via convective heat transfer with the external environment.

The sidewalls 14, 16 of the enclosure 10 with integrated dimples 26 present one or more advantageous functionalities during operation, including, but not limited to, the following:
1. Increased heat transfer between air and battery housing 13 by inducing turbulent flow, or mixed airflow, while in parallel reducing drag losses and thus pressure drop. In this way, the thermal performance of the system can be improved without the need of increasing fan volume flow rate and consequently dimensions and power consumption.
2. Through the contact between the dimples 26 and the battery sides 14, 16, greater stiffness and stability is provided, as well as allowing an easier mounting of the enclosure on preferably just 4 connection points 32 per side (e.g., bolts, screws, etc.). By means of this multiple-points contact between enclosure sidewalls 14, 16 and battery assembly 11, tolerances can be compensated allowing a constant and controlled gap 20 for the air flow A.
3. The side covers 14, 16 contact with the battery housing 13 drastically reduces vibration and consequent airborne noise (i.e., noise, vibration, harshness (NVH)).

Ventilation enclosures 10 according to embodiments of the present invention are particularly suitable for use with batteries and battery assemblies 11 in confined spaces and/or with maximal use time desired. For example, in certain embodiments, the ventilation enclosures 10 can be used with vehicle and/or large machinery applications. In particular embodiments, the ventilation enclosures 10 may be used with, and installed upon, a battery assembly 11 for an autonomous forklift truck.

As described herein, embodiments of the present invention provide integrated and fully scalable designs for forced convection air cooling, adaptable to different battery housing dimensions. The ventilation enclosure 10 can be easily installed and connected to the battery housing 11, while the cooling efficiency can be enhanced by increasing the number and power of the fans 18. The retrofit nature of the enclosure 10 allows also to guarantee ingress protection (IP) ratings for the battery: in fact, the installation is made only on the external surfaces.

Embodiments of the present invention can provide at least the following additional advantages over existing designs:
1. Simple design integration and removal of air ventilation system, already optimized to obtain homogeneous flow on battery surfaces. Thermal performance can be extended by increasing the number of fans on the top surface, where multiple ventilation seats can be filled with blower or simply covered by a cap.
2. Increased heat transfer coefficient on battery housing, still allowing a reduced pressure drop increase by means of local turbulence inducing dimples.
3. Multiple contact points between air leading plate (side of the enclosure) and battery housing. This is due to the dimples touching (and being pressed against) the battery housing upon installation.

Additional advantages of the various embodiments of the invention will be apparent to those skilled in the art upon review of the disclosure herein. It will be appreciated that the various embodiments described herein are not necessarily mutually exclusive unless otherwise indicated herein. For example, a feature described or depicted in one embodiment may also be included in other embodiments but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### Clauses

Embodiments of the present invention are also described by the following numbered clauses:
1. A ventilation enclosure configured to be installed onto a battery assembly, the ventilation enclosure comprising:
   an enclosure top comprising one or more ventilation elements installed therein; and
   a pair of opposing sidewalls, each of the sidewalls comprising a plurality of dimples formed therein and configured to contact an exterior housing of the battery assembly.
2. The enclosure of clause 1, wherein the dimples have a generally hemispherical geometry.
3. The enclosure of clauses 1 or 2, wherein the sidewalls comprise a metallic or polymeric material.
4. The enclosure of any of clauses 1-3, wherein the enclosure top and sidewalls comprise a unitary construct.
5. The enclosure of any of clauses 1-4, wherein the one or more ventilation elements comprise one or more fans.
6. A battery assembly comprising the ventilation enclosure of any of clauses 1-5 installed thereon.
7. The battery assembly of clause 6, further comprising a battery cell and a thermal barrier layer positioned between the battery cell and the exterior housing.
8 A method of cooling a battery assembly comprising:
providing a battery assembly having a ventilation enclosure installed thereon, the ventilation enclosure apparatus comprising:
   an enclosure top comprising one or more ventilation elements installed therein; and
   a pair of opposing sidewalls, each of the sidewalls comprising a plurality of dimples formed therein and contacting an exterior housing of the battery assembly so as to define a space between the sidewalls and an exterior housing of the battery assembly;
operating the one or more ventilation elements, thereby inducing airflow in the space between the sidewalls and an exterior housing of the battery assembly.
9 The method of clause 8, wherein the dimples deflect the airflow across an exterior surface of the battery assembly housing.
10. The method of clauses 8 or 9, wherein the airflow in the space between the sidewalls and the housing comprises turbulent air flow and/or mixed airflow.
11. The method of any of clauses 8-10, wherein heat generated within the battery assembly is transferred by conductive heat transfer from the battery assembly housing to the dimples of the enclosure sidewalls.
12. The method of any of clauses 8-11, wherein heat generated within the battery assembly is transferred by convective heat transfer from the battery assembly housing to the air flowing in the space between the housing and the sidewalls.

1. A ventilation enclosure configured to be installed onto a battery assembly, the ventilation enclosure comprising:
an enclosure top comprising one or more ventilation elements installed therein; and
a pair of opposing sidewalls, each of the sidewalls comprising a plurality of dimples formed therein and configured to contact an exterior housing of the battery assembly.

2. The enclosure of claim 1, wherein the dimples have a generally hemispherical geometry.

3. The enclosure of claim 1, wherein the sidewalls comprise a metallic or polymeric material.

4. The enclosure of claim 1, wherein the enclosure top and sidewalls comprise a unitary construct.

5. The enclosure of claim 1, wherein the one or more ventilation elements comprise one or more fans.

6. A battery assembly comprising the ventilation enclosure of claim 1 installed thereon.

7. The battery assembly of claim 6, further comprising a battery cell and a thermal barrier layer positioned between the battery cell and the exterior housing.

8. A method of cooling a battery assembly comprising:
providing a battery assembly having a ventilation enclosure installed thereon, the ventilation enclosure apparatus comprising:
an enclosure top comprising one or more ventilation elements installed therein; and
a pair of opposing sidewalls, each of the sidewalls comprising a plurality of dimples formed therein and contacting an exterior housing of the battery assembly so as to define a space between the sidewalls and an exterior housing of the battery assembly;
operating the one or more ventilation elements, thereby inducing airflow in the space between the sidewalls and an exterior housing of the battery assembly.

9. The method of claim 8, wherein the dimples deflect the airflow across an exterior surface of the battery assembly housing.

10. The method of claim 8, wherein the airflow in the space between the sidewalls and the housing comprises turbulent air flow and/or mixed airflow.

11. The method of claim 8, wherein heat generated within the battery assembly is transferred by conductive heat transfer from the battery assembly housing to the dimples of the enclosure sidewalls.

12. The method of claim 8, wherein heat generated within the battery assembly is transferred by convective heat transfer from the battery assembly housing to the air flowing in the space between the housing and the sidewalls.
